(19) United States
(12) Patent Application Publication
(10) Pub. No.: US 2012/0237894 A1
(43) Pub. Date: Sep. 20, 2012

(54) DENTAL APPARATUS

(75) Inventors: David John Maycher, Vancouver (CA); Igor J. Pesun, Winnipeg (CA)

(73) Assignee: UNIVERSITY OF MANITOBA, Winnipeg, MB (CA)

(21) Appl. No.: 13/388,800

(22) PCT Filed: Aug. 4, 2010
(86) PCT No.: PCT/CA2010/001204

§ 371 Date: May 16, 2012

Related U.S. Application Data
(60) Provisional application No. 61/231,262, filed on Aug. 4, 2009.

(51) Int. Cl. A61C 17/12; A61C 17/08

(52) U.S. Cl. 433/95; 433/91

(57) ABSTRACT

A dental apparatus for removing fluid from a patient's mouth during a dental procedure, the dental apparatus includes an intraoral tip having a wall defining a cavity, the wall having a plurality of apertures and at least one opening, the apertures being distributed over the wall; and a hollow tube coupled to the intraoral tip, the hollow tube for connecting the opening of the intraoral tip to a suction device. The intraoral tip is continuously within the patient's mouth during the dental procedure and the dental apparatus removes fluid from the patient's mouth through the apertures of said intraoral tip. In one embodiment, the dental apparatus further includes a valve for modulating the rate of fluid removal from the patient's mouth. In another embodiment, the dental apparatus further includes a fastener for securing the intraoral tip within the patient's mouth.

### FIELD OF THE INVENTION

This invention relates to an apparatus for removing fluid from a patient's mouth during dental procedures.

### BACKGROUND OF THE INVENTION

During dental procedures, a patient must sit still with their mouth open to allow a dental professional access inside the oral cavity using a variety of dental instruments. This open, mouth position allows a build-up of salivary fluids in a patient's mouth. In addition, water may be introduced to rinse the mouth during certain dental procedures. This build-up of moisture must be removed from the patient's mouth to prevent gagging, choking or undesirable swallowing.

Current moisture control devices, known in the art as moisture evacuators, are designed primarily for operation by a heath professional. In some cases, patients may exhibit anxiety over the use of moisture evacuators. One commonly used moisture control device is a saliva ejector, which is generally characterised by large partially-rigid tubing, fixed flow rates and a high degree of suction for quickly removing moisture and debris from a patient's mouth. In operation, a dental professional periodically inserts the tip of the saliva ejector into a patient's mouth to remove fluids and debris. The frequency of insertion is determined by the dental professional and can only occur as opportunities during the dental procedure permit or on an interruption basis when the patient demonstrates obvious discomfort or anxiety. The insertion of a large tube can be uncomfortable and may cause tissue abrasions and bruising. Some currently available dental moisture control device is expensive, and is designed and integrated with other existing dental machinery. Integrated products from sophisticated manufacturers are often not accessible or affordable to all dental practitioners.

### SUMMARY OF THE INVENTION

The embodiments of the present invention relate to an apparatus for moisture control in the oral cavity during dental procedures. The apparatus may be operated by a health professional or a patient. Operation and control of the apparatus by the patient helps reduce anxiety related to oral moisture evacuation by providing the patient with some control over the procedure.

One embodiment of the dental apparatus relates to a dental apparatus for removing fluid from a patient's mouth during a dental procedure. The dental apparatus includes an intraoral tip having a wall defining a cavity, and a hollow tube coupled to the intraoral tip. The wall has a plurality of apertures distributed over the wall and at least one opening. The hollow tube connects the opening of the intraoral tip to a suction device. The intraoral tip is continuously placed within the patient's mouth during the dental procedure and the dental apparatus removes fluid from the patient's mouth through the apertures of the intraoral tip.

According to one aspect, the apertures are evenly distributed between a first end and a second end of the intraoral tip. According to another aspect, the apertures 22 are unevenly distributed between the first end and the second end of the intraoral tip.

According to one aspect, the rate of fluid removal from the patient's mouth may be adjusted to be about equivalent the salivary flow rate.

Another embodiment of the dental apparatus further includes a valve for modulating the rate of fluid removal from the patient's mouth. According to one aspect, the valve is located between the intraoral tip and the suction device. According to another aspect, the valve is movable between a plurality of operating positions. According to yet another aspect, the valve is operable by the patient.

Another embodiment of the dental apparatus further includes a flow control switch in communication with the valve for enabling said patient to control said rate of fluid removal from their mouth. According to one aspect, the flow control switch moves the valve between a plurality of operating positions.

Another embodiment of the dental apparatus further includes a fastener for securing the intraoral tip within the patient's mouth. According to one aspect, the fastener is selected from the group including dental floss, a ring, a clip, and combinations thereof.

In one embodiment of the dental apparatus, the diameter of the apertures is from about 0.25 mm to about 3 mm.

In one embodiment of the dental apparatus, the length of the intraoral tip is from about 5 mm to about 40 mm.

In one embodiment of the dental apparatus, the internal diameter of the intraoral tip is from about 0.25 mm to about 10 mm.

According to one aspect, the intraoral tip is removably or permanently coupled to the hollow tube.

### BRIEF DESCRIPTION OF THE DRAWINGS

Embodiments of the present invention will be described with reference to the following drawings, in which like reference numerals denote like parts:

FIG. 1 is a top view of a dental apparatus according to an embodiment;

FIG. 2 is a top view of a dental apparatus according to another embodiment;

FIG. 3 is a top view of a dental apparatus according to another embodiment;

FIG. 4 is a schematic view of a dental apparatus of another embodiment received in a patient's mouth;

FIG. 5 is a top view of an intraoral tip of a dental apparatus according to another embodiment;

FIG. 6 is a top view of an intraoral tip of a dental apparatus according to another embodiment;

FIG. 7 is a top view of an intraoral tip of the dental apparatus of FIG. 1;

FIG. 8 is a top view of a dental apparatus according to another embodiment; and

FIG. 9 is a cross-sectional view of an intraoral tip of a dental apparatus according to another embodiment.

### DETAILED DESCRIPTION OF THE INVENTION

The embodiments of the present invention relate to a dental apparatus for moisture control in the oral cavity during dental procedures. The dental apparatus enables moisture removal from a patient's mouth.

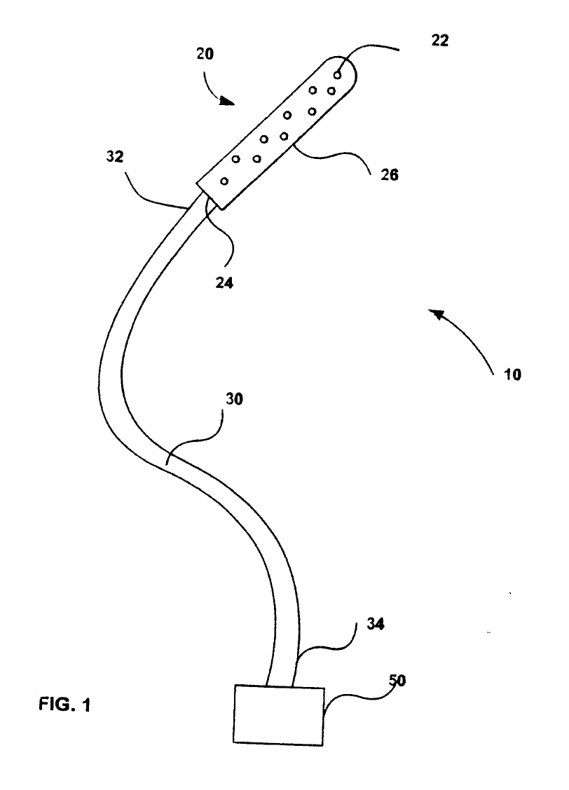

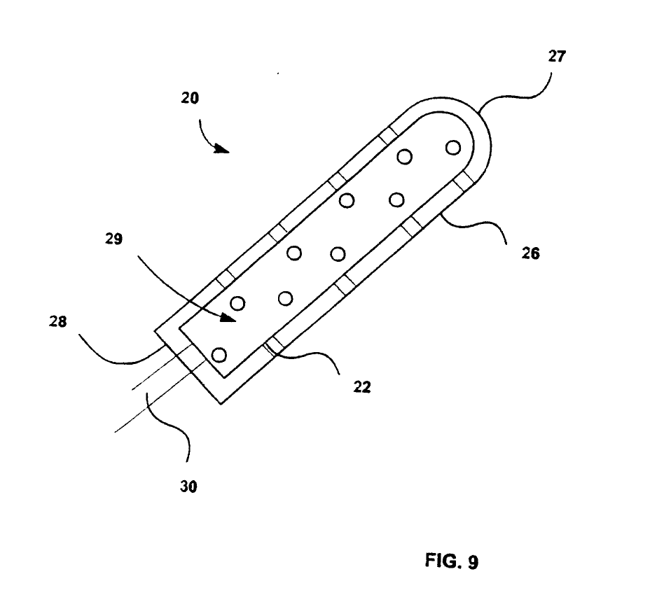

Referring to FIG. 1, a dental apparatus according to an embodiment of the present invention is indicated by reference numeral 10. An intraoral tip 20 of the dental apparatus 10 is coupled to a first end 32 of a hollow tube 30. A second end 34 of the hollow tube 30 is connected to a suction device 50 by any suitable connector known to those skilled in the art. The suction device 50 acts as a vacuum. The intraoral tip 20 comprises a wall 26 defining a cavity 29 and a plurality of apertures 22 (FIG. 9). The apertures 22 of the intraoral tip 20 extend through the wall 26 and are distributed over the wall 26 in a variety of configurations. In one embodiment, the intraoral tip 20 is coupled to the hollow tube 30 by a tube connector (not shown). The tube connector may be a fastener, an adhesive, a sleeve or any other suitable tube connector known to those skilled in the art. Alternatively, the intraoral tip 20 may be coupled to the hollow tube 30 by a fused joint. It would be appreciated by a person skilled in the art that the intraoral tip 20 may be removably coupled to the hollow tube 30 or permanently fixed thereto.

The apertures 22 are evenly distributed between a first end 27 and a second end 28 of the intraoral tip 20. As shown in FIGS. 1 and 9, the apertures 22 are provided in a repeating pattern over wall 26 of the intraoral tip 20. The diameter of the apertures 22 may range from about 0.25 mm to about 3 mm.

The apertures 22 may alternatively be unevenly distributed between the first end 27 and the second end 28 of the intraoral tip 20. The apertures 22 may alternatively be distributed proximate to the first end 27 of the intraoral tip 20. Alternatively, the apertures 22 may be distributed proximate to the second end 28 of the intraoral tip 20.

The intraoral tip 20 sized for a comfortable fit in a patient's mouth. During a dental procedure, the intraoral tip 20 is placed inside the patient's mouth continuously throughout the duration of the dental procedure. The intraoral tip 20 is generally between about 5 mm and about 40 mm in length and includes an internal diameter of between about 0.25 mm and about 10 mm. The internal diameter may also be referred to as the width for embodiments in which the cross-section of the intraoral tip 20 is not circular. The intraoral tip 20 is made of plastic and is rigid. The intraoral tip 20 may alternatively be made of a collapsible plastic that deforms when pressure is applied to the wall 26 of the intraoral tip 20. The pressure applied may temporarily deform the intraoral tip 20. The intraoral tip 20 is not limited to being made of a plastic material, it may be constructed from any suitable material. In one embodiment, the intraoral tip 20 is made of an autoclavable material. Alternatively, the intraoral tip 20 is made of a non-autoclavable material and is intended for a single use.

The hollow tube 30 is made of a polymer and is semi-rigid. The hollow tube 30 may alternatively be made of a rigid or flexible polymer material. The hollow tube 30 is not limited to being made of a polymer material, it may be constructed from any suitable material, such as plastic, polypropylene, PVC, and polystyrene, for example. The internal diameter of the hollow tube 30 is generally between about 0.25 mm and about 10 mm. In one embodiment, the hollow tube 30 is made of an autoclavable material. Alternatively, the hollow tube 30 is made of a non-autoclavable material and is intended for a single use.

The suction device 50 applies a vacuum force that causes fluids within the mouth of a patient to be drawn through apertures 22 of the intraoral tip 20, into the cavity 29, through opening 24, and into hollow tube 30 thereby allowing the intraoral tip 20 to remove moisture from a patient's mouth during a dental procedure. The hollow tube 30 defines a passageway for the fluid removed from the patient's mouth. In one embodiment, micro-particles smaller than the diameter of the apertures 22 are removed from the mouth of a patient. Suction devices are well known in the art and therefore will not be described further here.

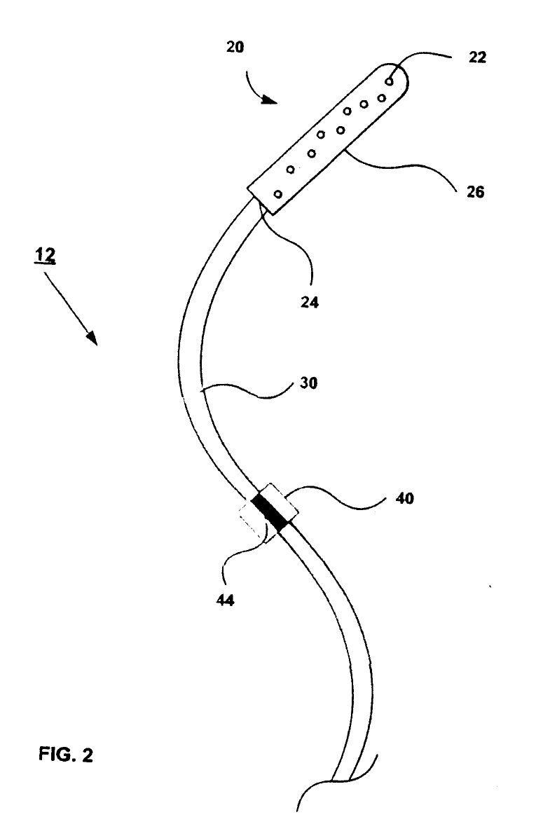

Referring to FIG. 2, another embodiment of a dental apparatus is indicated by reference numeral 12. The dental apparatus 12 is similar to the dental apparatus 10, however, further includes a valve 40 located between the intraoral tip 20 and the suction device 50. More specifically, the valve 40 is located between the first end 32 and the second end 34 of hollow tube 30. The valve 40 modulates the rate of fluid removal from the patient's mouth through the hollow tube 30 by opening, closing, or partially obstructing the passageway. In one embodiment, the valve 40 has a plurality of operating positions: in a closed position, no flow passes through the valve 40, in a partially open position, some flow passes through the valve 40 and in an open position, a maximum flow passes through the valve 40. The valve 40 is movable between the operating positions by a flow control switch 44 that is operable by the patient. The flow control switch 44 is in communication with the valve 40 and enables the patient to control the rate of fluid removal from their mouth during a dental procedure by selecting the desired operating position of the valve 40.

The operating positions of the valve 40 regulate the rate of fluid removal from the patient's mouth and may be set so that the partially open position allows a pre-determined amount of flow to pass through the valve 40, or alternatively, the operating positions of the valve 40 may be continuous between the closed position and the open position so that any amount of flow may be allowed to pass through the valve 40.

In one embodiment, the flow control switch 44 is a mechanical switch that physically moves the valve 40 between the plurality of operating positions. In one aspect, the mechanical switch is mounted on the hollow tube 30 and applies pressure directly to the hollow tube 30 adjusting the amount of flow through the hollow tube 30. Mechanical flow control switches are well known in the art and therefore will not be described further here. In another embodiment, the flow control switch is an electrical switch that actuates the valve 40. The electrical switch may include “up” and “down” buttons that actuate the valve 40 between the open and closed positions in increments having a pre-determined size. Electrical flow control switches are well known in the art and therefore will not be described further here.

In one embodiment the valve 40 is operable by one hand of the patient.

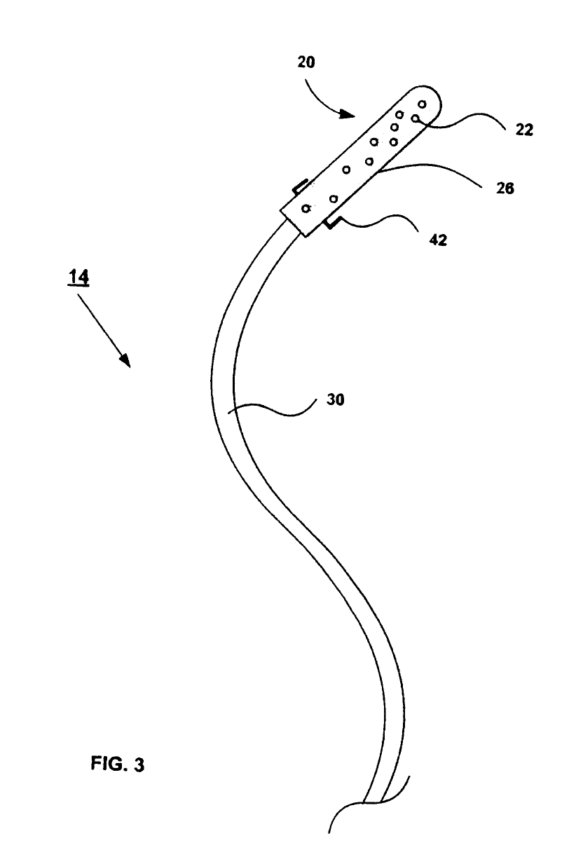

Referring to FIG. 3, another embodiment of the dental apparatus is indicated by reference numeral 14. The dental apparatus 14 is similar to the dental apparatus 10 and the dental apparatus 12, however, further includes a fastener 42 for securing the intraoral tip 20 within the mouth of a patient. The fastener 42 generally maintains the intraoral tip 20 in a constant position within the mouth. By restricting movement of the intraoral tip 20 within the mouth, abrasions or bruising on the floor of the mouth, tongue, and cheek areas are generally prevented.

In one embodiment, the fastener 42, for example dental floss, a ring, or a clip, enables attachment of the intraoral tip 20 to a tooth. Suitable fasteners are exemplified by a knotted or unknotted loop of dental floss, a ring comprising metal and/or plastics and/or composite materials, a clip comprising metal and/or plastics and/or composite materials, and the like. A suitable ring may be resilient or alternative non-resilient. The ring may additionally comprise two or more resilient prongs fashioned to releasingly engage a tooth when pressed thereupon. A suitable clip may comprise two opposing components engaged with a spring, fashioned into a clamp. The fastener 42 is attached to a tooth and the intraoral tip 20 is affixed to the fastener 42 thereby securing the intraoral tip 20 inside the mouth of a patient. Comfortable placement of both the fastener 42 and the intraoral tip 20 may be facilitated by one of the patient or a dental professional. The fastener 42 may be moved from one tooth to another as necessary, depending on the dental procedure and the comfort of the patient. The intraoral tip 20 is continuously fixed by fastener 42 inside the patient's mouth throughout the length of a dental procedure. In one embodiment, the fastener 42 is injection moulded and constructed from resilient synthetic materials. The fastener 42 is alternatively made of rigid materials. The fastener 42 may be constructed from any suitable material. A person skilled in the art would understand the dimensions of the fastener 42 are suitable for affixing the fastener 42 to a tooth of a patient. In one embodiment, the fastener 42 is made of an autoclavable material. Alternatively, the fastener is made of a non-autoclavable material and is intended for a single use. In one embodiment, the fastener 42 is securely coupled to the intraoral tip 20. In another embodiment, the fastener 42 may be removably coupled to the intraoral tip 20. In still another embodiment, the fastener 42 may be securely or removably coupled to the tube 30.

A single-use hollow tube, intraoral tip, and fastener may be sterilized by one of a suitable radiation procedure, exemplified by gamma irradiation or a suitable chemical gas infiltration, exemplified by ethylene oxide infiltration and steam autoclave sterilization.

When an embodiment of the dental apparatus is in operation, the rate of fluid removal from a patient's mouth is generally at a low rate of fluid removal and does not over-dry the mouth. The rate of fluid removal is the rate at which saliva is being sucked out of the patient's mouth. More desirably, the rate of fluid removal from the patient's mouth is about equivalent the salivary flow rate. Typical salivary flow rates range from between about 0.1 ml/minute and about 0.6 ml/minute, however, a person skilled in the art would understand that salivary flow rates vary between patients. A low rate for fluid removal from a patient's mouth may be achieved by using: a small internal diameter hollow tube 30, where the diameter is between about 0.25 mm and about 10 mm; a valve 40, to control the rate of fluid removal through the hollow tube; a suction device known to those skilled in the art; and combinations thereof.

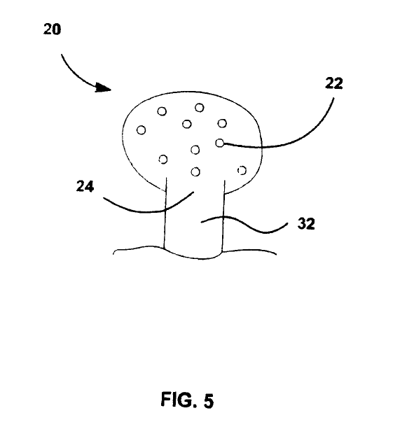

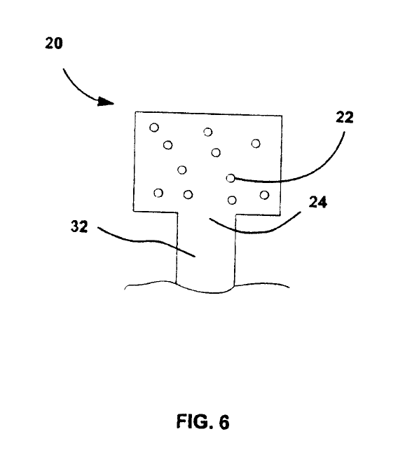

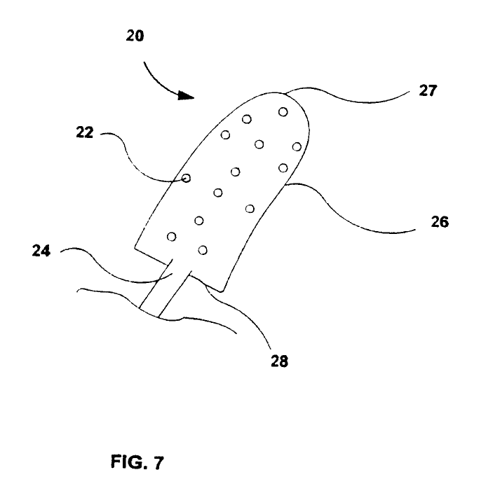

Alternative embodiments of the intraoral tip 20 are shown in FIG. 5, FIG. 6 and FIG. 7. The intraoral tip 20 may be circular as shown in FIG. 5, square as shown in FIG. 6, and cylindrical as shown in FIG. 6. The intraoral tip 20 may alternatively be rectangular, ovular, and bulbous. It will be appreciated by a person skilled in the art that the intraoral tip 20 may be any suitable shape and size. In general, the dimensions fall about within the ranges described in relation to the intraoral tip 20 of FIG. 1.

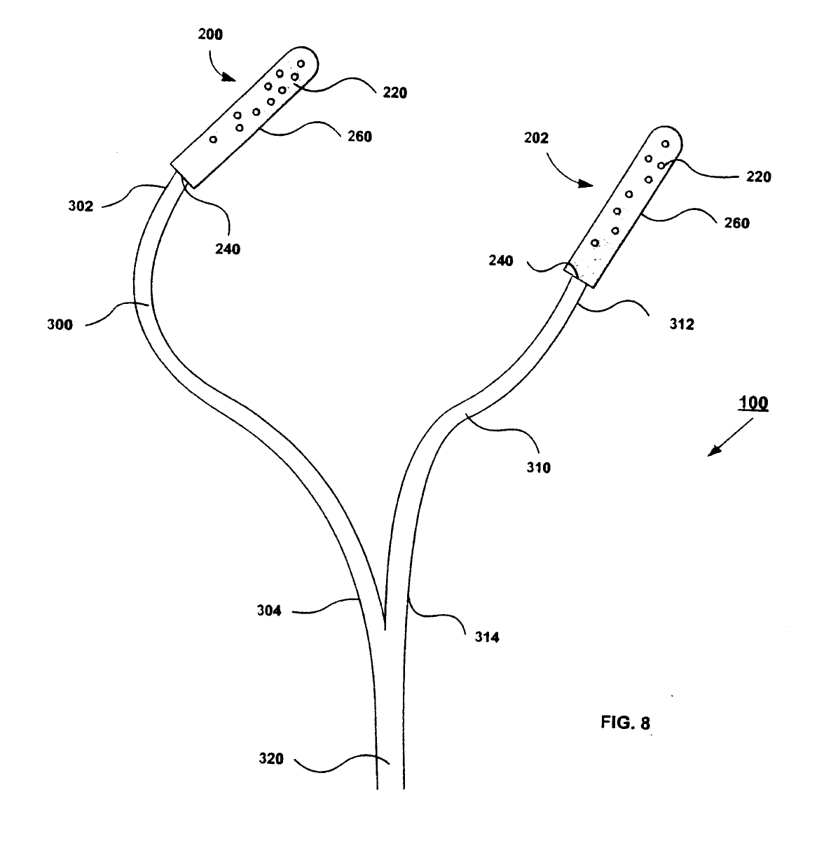

Referring to FIG. 8, another embodiment of a dental apparatus 100 includes a first intraoral tip 200 and a second intraoral tip 202. As shown, the first intraoral tip 200 of the dental apparatus 100 is coupled to a first end 302 of a first hollow tube 300 and the second intraoral tip 202 of the dental apparatus 100 is coupled to a first end 312 of a second hollow tube 310. A second end 304 of the first hollow tube 300 and a second end 314 of second hollow tube 310 are connected together and joined to a third hollow tube 320. The third hollow tube 320 is connected to a suction device (not shown) by any suitable connector known to those skilled in the art. Each of the first and second intraoral tips 200, 202 comprise a wall 260 defining a cavity (not shown) and a plurality of apertures 220. The apertures 220 of the intraoral tips 200, 202 extend through the wall 260 and are distributed over the wall 260 in a variety of configurations. In one embodiment, the intraoral tip 200, 202 is coupled to the hollow tube 300, 310 by a tube connector (not shown). It would be appreciated by a person skilled in the art that the intraoral tip 200, 202 may be removably coupled to the hollow tube 300, 310 or permanently fixed thereto.

In an alternative embodiment, the second end 304 of the first hollow tube 300 connects to a first suction device and the second end 314 of the second hollow tube 310 connects to a second suction device.

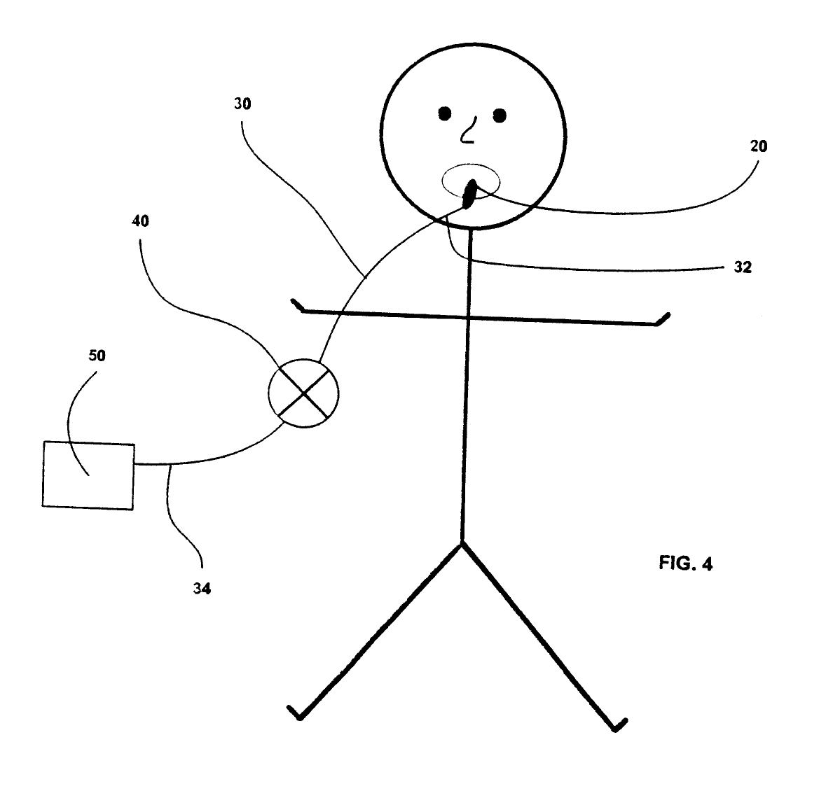

In preparation for use in a dental procedure, the intraoral tip 20 of the dental apparatus of FIG. 4 is placed inside a patient's mouth. The intraoral tip 20 is secured within the mouth by fastener 42 continuously for the duration of the dental procedure. The intraoral tip 20 is connected through opening 24 to a suction device 50 by a hollow tube 30. The hollow tube 30 protrudes from the patient's mouth and a length of the hollow tube extends across the body of the patient. The second end 34 of the hollow tube 30 is connected to a suction device 50 by any suitable connector. On beginning the dental procedure, the suction device 50 is turned on and applies suction indirectly to the intraoral tip 20. This suction pressure enables the removal of moisture from the patient's mouth at a low rate of fluid removal, more specifically at a rate of fluid removal about the salivary flow rate of the patient. Fluid within a patient's mouth flows through the apertures 22 and into the cavity 29 of the intraoral tip 20. Fluid exits the intraoral tip 20 through opening 24 and flows into the hollow tube 30. In the event an aperture 22 of the intraoral tip 20 becomes blocked, the plurality of other apertures 22 distributed over the wall 26 of the intraoral tip 20 enable the dental apparatus to function effectively. Where the blockage of an aperture 22 of the intraoral tip 20 is due to the intraoral tip 20 touching the cheek tissue of the patient, the low rate of fluid removal of the dental apparatus generally prevents the patient from incurring abrasions and/or bruising of the cheek tissue. The patient controls the rate of fluid removal by manipulating valve 40. As the patient perceives moisture building up inside their mouth, the patient may operate valve 40 to either increase or decrease the rate of fluid removal thereby adjusting the moisture level in their mouth.

By allowing the patient to control the moisture removal process, anxiety about a health professional-operated moisture control device is removed. The dental apparatus is continuously located in the patient's mouth during a dental procedure so no discomfort is experienced due to repeated insertion and removal of the moisture control device during the dental procedure. In addition, the patient experiences little or no discomfort while the dental apparatus is continuously located in the mouth because of the small size and streamlined shape of the intraoral tip 20. The ability to control the amount of fluid in the mouth further increases the patient's level of comfort so that the patient is able to relax more effectively while undergoing the dental procedure.

The above-described embodiments have been provided as examples, for clarity in understanding the invention. A person of skill in the art will recognize that alterations, modifications and variations may be effected to the embodiments described above while remaining within the scope of the invention as defined by the claims appended hereto.

What is claimed is:

1. A dental apparatus for removing fluid from a patient's mouth during a dental procedure, said dental apparatus comprising:
an intraoral tip having a wall defining a cavity, said wall having a plurality of apertures and at least one opening, said apertures being distributed over the wall; and
a hollow tube coupled to said intraoral tip, said hollow tube for connecting said opening of said intraoral tip to a suction device;
wherein said intraoral tip is continuously within said patient's mouth and wherein said dental apparatus removes fluid from said patient's mouth through said apertures of said intraoral tip.

2. A dental apparatus according to claim 1 further comprising a valve for modulating the rate of fluid removal from said patient's mouth.

3. A dental apparatus according to claim 2, wherein said valve is located between said intraoral tip and said suction device.

4. A dental apparatus according to claim 2, wherein said valve has a plurality of operating positions and is moveable between said operating positions.

5. A dental apparatus according to claim 2 further comprises a flow control switch, wherein said flow control switch is in communication with said valve for enabling said patient to control said rate of fluid removal from their mouth.

6. A dental apparatus according to claim 5, wherein said flow control switch moves said valve between a plurality of operating positions.

7. A dental apparatus according to claim 1, wherein the rate of fluid removal from said patient's mouth is about said salivary flow rate.

8. A dental apparatus according to claim 2, wherein said valve is operable by said patient.

9. A dental apparatus according to claim 1 further comprising a fastener for securing said intraoral tip within said patient's mouth.

10. A dental apparatus according to claim 9, wherein said fastener is selected from the group comprising dental floss, a ring, a clip, and combinations thereof.

11. A dental apparatus according to claim 9, wherein said fastener attaches said intraoral tip to a tooth within said patient's mouth.

12. A dental apparatus according to claim 1, wherein said apertures are evenly distributed between a first end and a second end of said intraoral tip.

13. A dental apparatus according to claim 1, wherein said apertures are unevenly distributed between a first end and a second end of said intraoral tip.

14. A dental apparatus according to claim 1, wherein said apertures are distributed proximate to a first end of said intraoral tip.

15. A dental apparatus according to claim 1, wherein said apertures are distributed proximate to a second end of said intraoral tip.

16. A dental apparatus according to claim 1, wherein a diameter of said apertures is from about 0.25 mm to about 3 mm.

17. A dental apparatus according to claim 1, wherein a length of said intraoral tip is from about 5 mm to about 40 mm.

18. A dental apparatus according to claim 1, wherein an internal diameter of said intraoral tip is from about 0.25 mm to about 10 mm.

19. A dental apparatus according to claim 1, wherein said intraoral tip is removably coupled to said hollow tube.

20. A method for removing fluid from a patient's mouth during a dental procedure, said method comprising:
inserting a dental apparatus into said patient's mouth, said dental apparatus comprising a hollow tube coupled to an intraoral tip, said intraoral tip having a wall defining a cavity, a plurality of apertures provided in said wall and an opening, a first end of a hollow tube being coupled to said opening of said intraoral tip;
removing fluid from said patient's mouth by operating a suction device, said suction device being coupled to a second end of said hollow tube;
wherein said dental apparatus is operated by said patient to remove fluid from said patient's mouth.

21. A method as claimed in claim 20, further comprising a valve for modulating the rate of fluid removal from said patient's mouth, said valve being adjustable by said patient.

22. A method as claimed in claim 21, wherein said valve is located between said intraoral tip and said suction device.

23. A method as claimed in claim 21, wherein said valve has a plurality of operating positions and is moveable between said operating positions.

24. A method as claimed in claim 21, further comprising a flow control switch, wherein said flow control switch is in communication with said valve for enabling said patient to control said rate of fluid removal from their mouth.

25. A method as claimed in claim 24, wherein said flow control switch is movable by said patient to move said valve between a plurality of operating positions.

26. A method as claimed in claim 21, wherein said the rate of fluid removal from said patient's mouth is about said salivary flow rate.
